(19) United States
(12) Patent Application Publication
(10) Pub. No.: US 2026/0128415 A1
(43) Pub. Date: May 7, 2026

(54) BATTERY PACK

(71) Applicant: ISUZU MOTORS LIMITED, Yokohama-shi (JP)

(72) Inventors: Takanori SHIMIZU, Fujisawa-shi (JP); Hayato SAITO, Fujisawa-shi (JP); Kenji OSUMI, Fujisawa-shi (JP); Ayaka NAKASHIMA, Fujisawa-shi (JP)

(21) Appl. No.: 19/337,051

(22) Filed: Sep. 23, 2025

(30) Foreign Application Priority Data
Nov. 7, 2024 (JP) 2024-195197

(51) Int. Cl. H01M 10/6568; H01M 10/613

(52) U.S. Cl. CPC H01M 10/6568; H01M 10/613; H01M 2220/20

(57) ABSTRACT

A battery pack includes two battery modules, each having a cooling member for cooling a battery cell, and spaced apart from each other in the left-right direction, a supply pipe provided between the two battery modules in the front-rear direction, two first branch pipes, branched from the supply pipe to the left-right direction and respectively guide the refrigerant into the cooling members of the two battery modules, a discharge pipe provided between the two battery modules in the front-rear direction, and two second branch pipes that branch from the discharge pipe along the left-right direction and into which the refrigerant is discharged from the cooling member of each of the two battery modules. The supply pipe and the discharge pipe are arranged in the vertical direction.

### CROSS-REFERENCE TO RELATED APPLICATIONS

The present application claims priority to Japanese Patent Applications number 2024-195197, filed on November 7, 2024 contents of which are incorporated herein by reference in their entirety.

### BACKGROUND OF THE INVENTION

The present disclosure relates to a battery pack having a plurality of battery modules. In Japanese Unexamined Patent Application Publication No. 2019-186149, a refrigerant supply pipe and a refrigerant discharge pipe are provided laterally in parallel between battery modules disposed on the left and right sides. In addition, a branch path that connects a refrigerant jacket of each battery module to the refrigerant supply pipe and the refrigerant discharge pipe is provided.

When the refrigerant supply pipe and the refrigerant discharge pipe are disposed side-by-side, the lengths of the branch paths from the refrigerant supply pipe to the left and right battery modules become different. In this case, since the flow of refrigerant to the cooling jackets of the left and right battery modules is not uniform, cooling of the left and right battery modules cannot be performed uniformly.

### BRIEF SUMMARY OF THE INVENTION

The present disclosure has been made in view of these points, and its object is to uniformly cool a plurality of battery modules.

A first aspect of the present disclosure provides a battery pack including: two battery modules, each having a battery cell and a cooling member, with a flow path therein, for cooling the battery cell, and spaced apart from each other in a first direction; a supply pipe provided between the two battery modules along a second direction orthogonal to the first direction and through which refrigerant supplied to the flow path of the cooling member flows; two first branch pipes that branch from the supply pipe along the first direction and respectively guide the refrigerant into the flow paths of the cooling members of the two battery modules; a discharge pipe provided between the two battery modules along the second direction, through which discharged refrigerant flows; and two second branch pipes that branch from the discharge pipe along the first direction and into which the refrigerant is discharged from the flow path of the cooling member of each of the two battery modules, wherein the supply pipe and the discharge pipe are arranged in a third direction orthogonal to the first direction and the second direction.

### BRIEF DESCRIPTION OF THE DRAWINGS

FIG. 1 is a schematic diagram showing the plan-view layout of a battery pack 1 according to one embodiment.

FIG. 2 is a view taken along line A-A of FIG. 1.

FIG. 3 is a perspective view showing a first support member 62 that supports a coupling member 24 of a supply pipe 20 and a coupling member 44 of a discharge pipe 40.

FIG. 4 is a front view of a first support member 62.

FIG. 5 is a perspective view showing a second support member 72.

FIG. 6 is a schematic view showing a first support member 82 according to a modification.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### Configuration of a battery pack

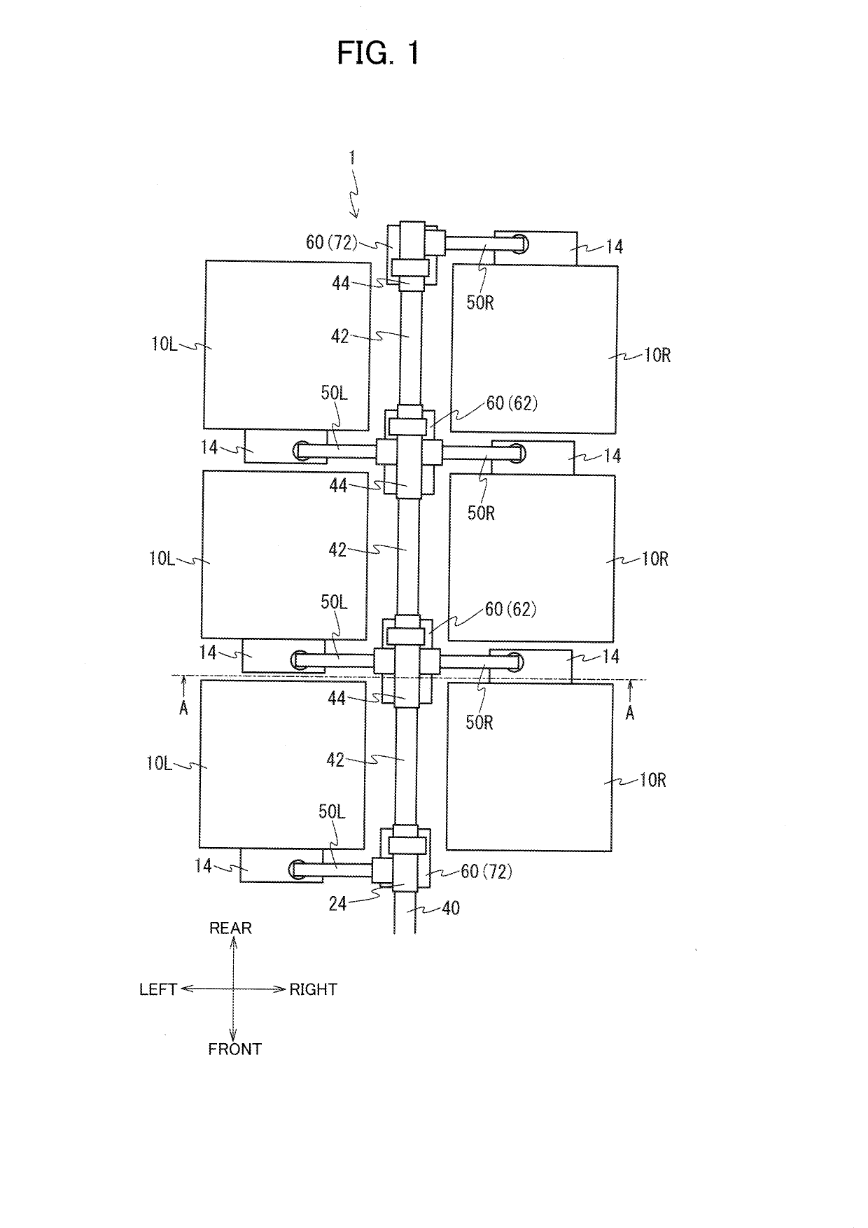

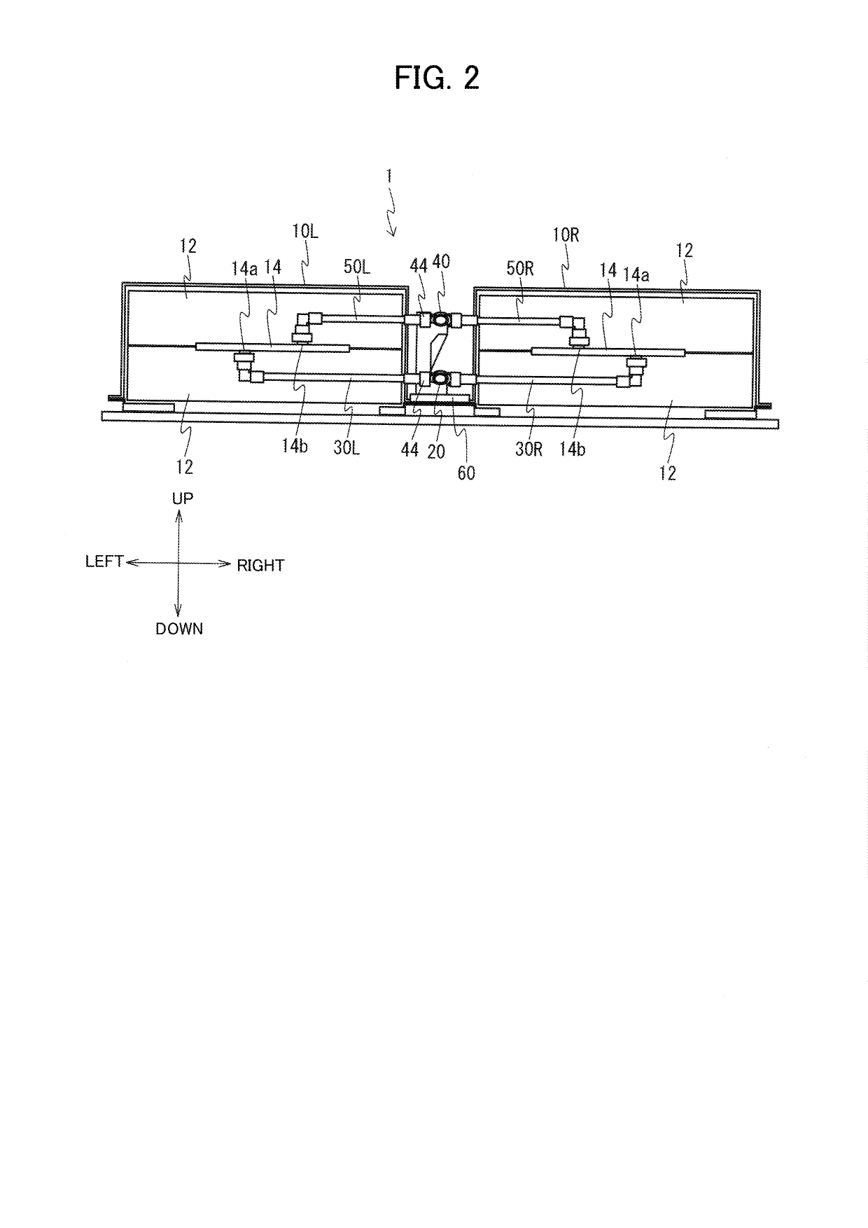

FIG. 1 is a schematic diagram showing the plan-view layout of a battery pack 1 according to one embodiment. FIG. 2 is a view taken along line A-A of FIG. 1. In FIG. 1, a case and a lid of the battery pack 1 are omitted for convenience of description.

The battery pack 1 is mounted in a vehicle. For example, the battery pack 1 is mounted in a vehicle having a ladder frame structure. Specifically, the battery pack 1 is attached between a pair of side frames.

As illustrated in FIG. 2, the battery pack 1 includes a battery module 10L, a battery module 10R, a supply pipe 20, a first branch pipe 30L, a first branch pipe 30R, a discharge pipe 40, a second branch pipe 50L, a second branch pipe 50R, and a support member 60.

The battery module 10L is located on the left side of the supply pipe 20, and the battery module 10R is located on the right side of the supply pipe 20. Therefore, the battery module 10L and the battery module 10R are two battery modules spaced apart from each other in the left-right direction (first direction).

Three battery modules 10L are provided as an example, and are disposed at predetermined intervals in the front-rear direction (second direction) orthogonal to the left-right direction as shown in FIG. 1. Three battery modules 10R are also provided as an example, and are disposed at predetermined intervals in the front-rear direction.

The configuration of the battery module 10L and the configuration of the battery module 10R are the same. Hereinafter, the battery module 10L and the battery module 10R will collectively be referred to as a battery module 10.

As illustrated in FIG. 2, the battery module 10 includes a battery cell 12 and a cooling member 14. Two battery cells 12 are provided vertically. The cooling member 14 is a cooling plate that is sandwiched between the two battery cells 12 and cools the two battery cells 12. The cooling member 14 extends in the front-rear direction. The cooling member 14 has, inside it, a flow path through which refrigerant flows. Furthermore, the cooling member 14 includes an inlet portion 14a into which the refrigerant flows into the flow path and an outlet portion 14b from which the refrigerant flows out of the flow path. The inlet portion 14a is located on the lower surface side of the cooling member 14, and the outlet portion 14b is located on the upper surface side of the cooling member 14.

As illustrated in FIG. 1, the cooling member 14 of the battery module 10L protrudes forward in the front-rear direction relative to the battery module 10L, and the cooling member 14 of the battery module 10R protrudes rearward in the front-rear direction relative to the battery module 10R.

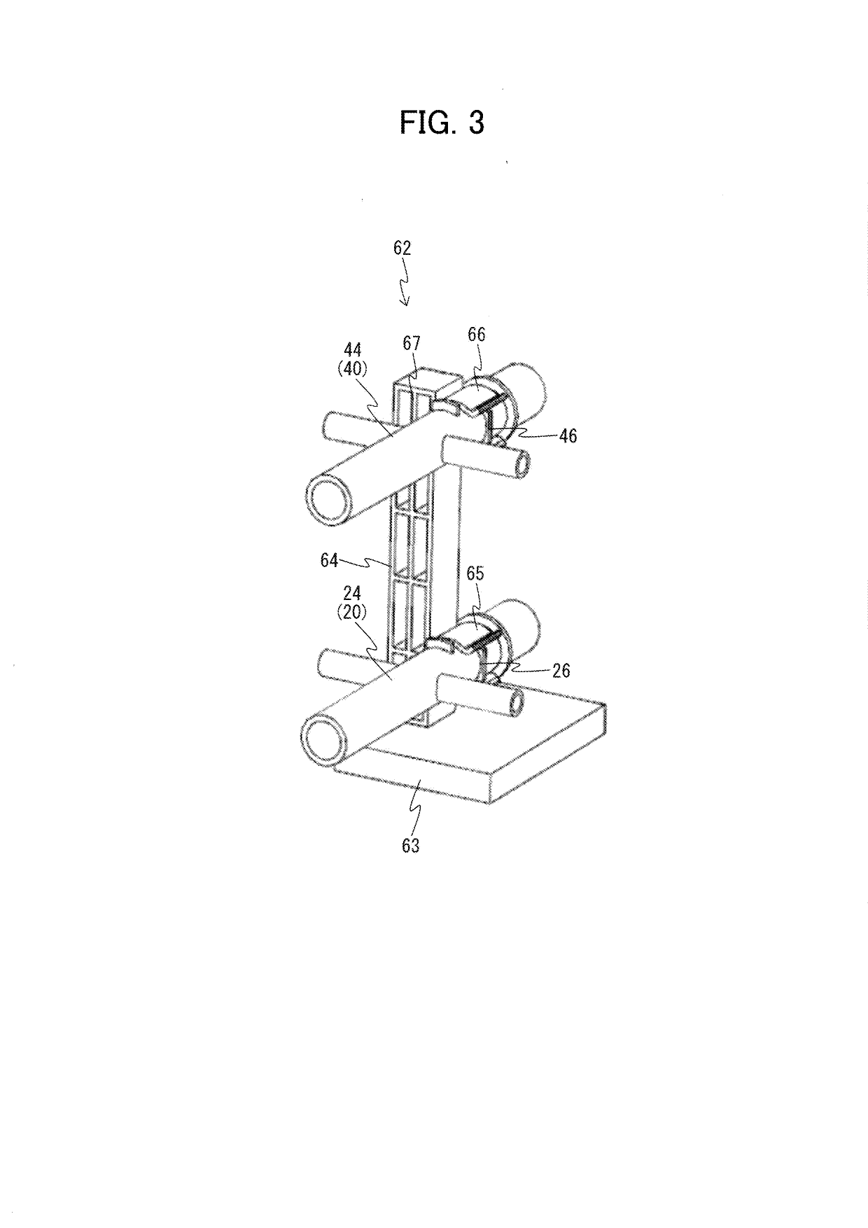

The supply pipe 20 is a flow passage through which refrigerant supplied to the cooling member 14 of the battery module 10 flows. The supply pipe 20 is provided along the front-rear direction between the two battery modules 10. Here, the supply pipe 20 is formed by interposing a coupling member 24 (see FIG. 3) between tubes forming the flow passage. The refrigerant is supplied to and flows into the supply pipe 20 by a pump or the like (not shown).

As shown in FIG. 2, the supply pipe 20 is located at the center between the battery module 10L and the battery module 10R in the left-right direction. The supply pipe 20 is provided in a straight line parallel to the front-rear direction. In other words, the supply pipe 20 is provided such that it is parallel to the direction in which the plurality of battery modules 10L (battery modules R) are disposed. The supply pipe 20 is located below the discharge pipe 40 in the vertical direction. In a plan view of the battery pack 1, the supply pipe 20 is located at the same position as the discharge pipe 40, and therefore the supply pipe 20 is not shown in FIG. 1.

As illustrated in FIG. 2, the first branch pipe 30L is a flow passage branched from the supply pipe 20 toward the battery module 10L. The first branch pipe 30L guides the refrigerant, branched from the supply pipe 20, into the flow path of the cooling member 14 of the battery module 10L. Three first branch pipes 30L are provided, and each of the first branch pipes 30L guides the refrigerant into the inlet portion 14a of the cooling member 14 of the corresponding battery module 10L. The three first branch pipes 30L branch from the supply pipe 20 along the left-right direction, specifically, from the peripheral surface of the coupling member 24.

As illustrated in FIG. 2, the first branch pipe 30R is a flow passage branched from the supply pipe 20 toward the battery module 10R. The first branch pipe 30R guides the refrigerant, branched from the supply pipe 20, into the flow path of the cooling member 14 of the battery module 10R. Three first branch pipes 30R are provided, and each of the first branch pipes 30R guides the refrigerant into the inlet portion 14a of the cooling member 14 of the corresponding battery module 10R. The three first branch pipes 30R branch from the supply pipe 20 along the left-right direction, specifically, from the peripheral surface of the coupling member 24.

As described above, since the supply pipe 20 is located at the center between the battery module 10L and the battery module 10R in the left-right direction, the length of the first branch pipe 30L is the same as the length of the first branch pipe 30R. Accordingly, the flow of the refrigerant flowing to the cooling member 14 of the battery module 10L via the first branch pipe 30L and the flow of the refrigerant flowing to the cooling member 14 of the battery module 10R via the second branch pipe 50R are made uniform, whereby the battery module 10L and the battery module 10R can be uniformly cooled. As a result, since the six battery modules 10 in the battery pack 1 are cooled uniformly, it is possible to suppress a decrease in performance of the battery pack 1 due to a decrease in cooling performance of some of the battery modules 10.

The discharge pipe 40 is a flow passage through which the refrigerant discharged from the cooling member 14 of the battery module 10 flows. Similarly to the supply pipe 20, the discharge pipe 40 is provided along the front-rear direction between the two battery modules 10. As shown in FIG. 1, the discharge pipe 40 is formed by interposing a coupling member 44 between tubes 42 that form the flow passage. The refrigerant discharged from the discharge pipe 40 is sent to a radiator of the vehicle, where it is cooled by, for example, a pump or the like. The refrigerant cooled by the radiator is sent to the supply pipe 20 and is reused to cool the battery module 10.

The discharge pipe 40 is located centrally between the battery module 10L and the battery module 10R in the left-right direction. As shown in FIG. 2, the discharge pipe 40 is arranged alongside the supply pipe 20 in the left-right direction, and both are located in the vertical direction (third direction), which is orthogonal to both the left-right direction and the front-rear direction. Specifically, the discharge pipe 40 is, in the vertical direction, spaced apart from the supply pipe 20 by a predetermined distance. Here, the discharge pipe 40 is located above the supply pipe 20 in the vertical direction.

The discharge pipe 40 is provided in a straight line parallel to the front-rear direction (direction in which the battery modules 10L and 10R are arranged), and is located at the same position as the supply pipe 20 in the left-right direction. Therefore, the supply pipe 20 is located directly below the discharge pipe 40.

The second branch pipe 50L is a flow passage branched from the discharge pipe 40 toward the battery module 10L. The second branch pipe 50L discharges the refrigerant from the flow path of the cooling member 14 of the battery module 10L into the discharge pipe 40. The number of the second branch pipes 50L corresponds to the number of the battery modules 10L, and specifically, three second branch pipes 50L are provided. Each of the second branch pipes 50 guides the refrigerant, discharged from the outlet portion 14b of the cooling member 14 of the corresponding battery module 10L, into the discharge pipe 40. The three second branch pipes 50L branch from the discharge pipe 40 (specifically, the peripheral surface of the coupling member 44) along the left-right direction. The second branch pipe 50L is located directly above the first branch pipe 30L in the vertical direction.

The second branch pipe 50R is a flow passage branched from the discharge pipe 40 toward the battery module 10R. The second branch pipe 50R discharges the refrigerant from the flow path of the cooling member 14 of the battery module 10R into the discharge pipe 40. The number of the second branch pipes 50R corresponds to the number of the battery modules 10R, specifically, three second branch pipes 50R are provided, and each of the second branch pipes 50 guides the refrigerant, discharged from the outlet portion 14b of the cooling member 14 of the corresponding battery module 10R, into the discharge pipe 40. The three second branch pipes 50R branch from the discharge pipe 40 (specifically, the peripheral surface of the coupling member 44) along the left-right direction. The second branch pipe 50R is located directly above the first branch pipe 30R in the vertical direction.

As described above, since the discharge pipe 40 is located at the center between the battery module 10L and the battery module 10R in the left-right direction, the length of the second branch pipe 50L is the same as the length of the second branch pipe 50R. Accordingly, the flow of the refrigerant discharged from the outlet portion 14b of the cooling member 14 of the battery module 10L to the second branch pipe 50L and the flow of the refrigerant discharged from the outlet portion 14b of the cooling member 14 of the battery module 10R to the second branch pipe 50R are made uniform, whereby the battery module 10L and the battery module 10R can be uniformly cooled.

The support member 60 is provided along the vertical direction as shown in FIG. 2, and supports the supply pipe 20 and the discharge pipe 40. The support member 60 supports the portion of the supply pipe 20 that branches into the first branch pipes 30L and 30R. The support member 60 also supports the portion of the discharge pipe 40 that branches into the second branch pipes 50L and 50R. Specifically, the support member 60 supports the coupling member 24 of the supply pipe 20 and the coupling member 44 of the discharge pipe 40. In the present embodiment, the coupling member 24 corresponds to a first coupling member, and the coupling member 44 corresponds to a second coupling member.

As an example, four support members 60 are provided, and the four support members 60 are disposed in the front-rear direction at predetermined intervals, as shown in FIG. 1. The four support members 60 support the supply pipe 20 and the discharge pipe 40 such that the supply pipe 20 and the discharge pipe 40 are spaced apart by a predetermined distance in the vertical direction and located at the same position in the left-right direction. Specifically, the four support members 60 support the supply pipe 20 and the discharge pipe 40 such that the supply pipe 20 is located directly below the discharge pipe 40 in the vertical direction. Since the support member 60 supports the supply pipe 20 below the discharge pipe 40 in the vertical direction, the air remaining in the first branch pipes 30L and 30R, the cooling member 14, and the second branch pipes 50L and 50R can be more easily discharged by the flow of the refrigerant. This increases the efficiency of the refrigerant in performing cooling.

As shown in FIG. 1, the four support members 60 are two first support members 62 and two second support members 72. The two first support member 62 are centrally located in the front-rear direction, and the two second support member 72 are located at the front and rear ends, respectively, in the front-rear direction.

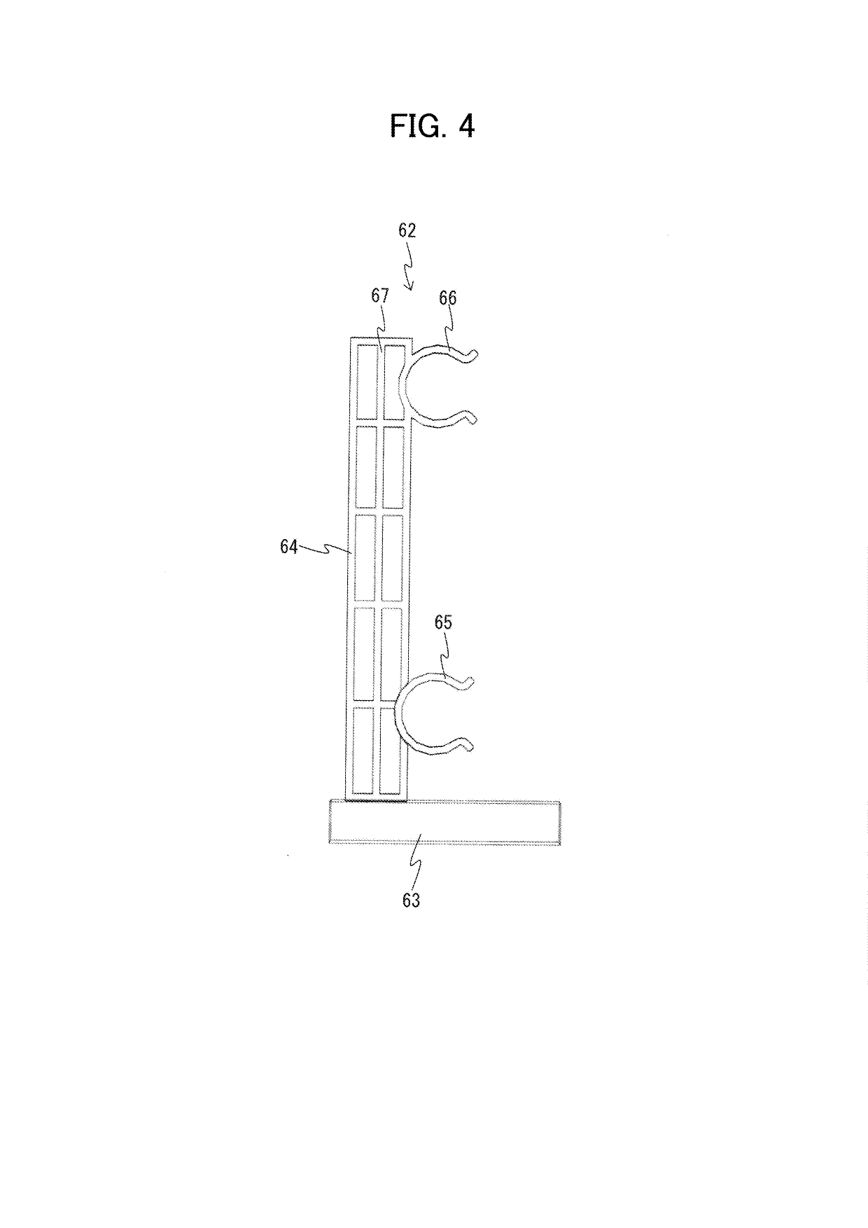

FIG. 3 is a perspective view illustrating the first support member 62 that supports the coupling member 24 of the supply pipe 20 and the coupling member 44 of the discharge pipe 40. FIG. 4 is a front view of the first support member 62. The first support member 62 includes a base portion 63, a main body 64, a first clip portion 65, a second clip portion 66, and a reinforcing portion 67.

The base portion 63 is a plate portion serving as a base of the first support member 62. The base portion 63 is fixed to the case of the battery pack 1. The main body 64 is the structural core of the first support member 62. The main body 64 extends upward from the base portion 63. The main body 64 is formed with ribs extending along the vertical direction. The first clip portion 65 and the second clip portion 66 are provided in the main body 64.

The first clip portion 65 grips the outer periphery of the supply pipe 20. Specifically, as illustrated in FIG. 3, the first clip portion 65 grips the outer periphery of the coupling member 24 of the supply pipe 20. The first clip portion 65 has a C-shape. In this way, when the battery pack 1 is manufactured, the coupling member 24 of the supply pipe 20 can be easily inserted into the first clip portion 65. The first clip portion 65 is located below the center of the main body 64 in the vertical direction.

As shown in FIG. 3, a first rib 26 is provided at a predetermined position along the circumferential direction on the outer periphery of the supply pipe 20 (specifically, the coupling member 24). The first rib 26 is located at a distal end opening of the first clip portion 65 when the first clip portion 65 grips the outer periphery of the coupling member 24. The first rib 26 has a function of preventing rotation of the supply pipe 20 because the first rib 26 comes into contact with the distal end of the first clip portion 65 when an operator accidentally attempts to turn the supply pipe 20. Further, the operator can prevent erroneous assembly by inserting the coupling member 24 of the supply pipe 20 into the first clip portion 65 using the first rib 26 as a positioning reference.

The second clip portion 66 grips the outer periphery of the discharge pipe 40. Specifically, as shown in FIG. 3, the second clip portion 66 grips the outer periphery of the coupling member 44 of the discharge pipe 40. The second clip portion 66 has a C-shape. In this way, when the battery pack 1 is manufactured, the coupling member 44 of the discharge pipe 40 can be easily inserted into the second clip portion 66. The second clip portion 66 is located above the center of the main body 64 in the vertical direction. Here, the second clip portion 66 is located at the upper end of the main body 64.

As shown in FIG. 3, a second rib 46 is provided at a predetermined position along the circumferential direction on the outer periphery of the discharge pipe 40 (specifically, the coupling member 44). The second rib 46 is located at a distal end opening of the second clip portion 66 when the second clip portion 66 grips the outer periphery of the coupling member 44. The second rib 46 has a function of preventing rotation of the discharge pipe 40 because the second rib 46 comes into contact with the distal end of the second clip portion 66 when the operator accidentally attempts to turn the discharge pipe 40. Further, the operator can prevent erroneous assembly by inserting the coupling member 44 of the discharge pipe 40 into the second clip portion 66 using the second rib 46 as a positioning reference.

By being coupled to the second clip portion 66, the reinforcing portion 67 functions to reinforce the gripping force of the C-shaped second clip portion 66. The reinforcing portion 67 extends upward from the main body 64 to a position above the second clip portion 66. Specifically, as shown in FIG. 4, the reinforcing portion 67 is provided such that it is coupled to the opposite side of the distal end of the second clip portion 66. In this way, since the rigidity of the second clip portion 66 located at the upper end of the main body 64 is increased, the second clip portion 66 can appropriately grip the discharge pipe 40.

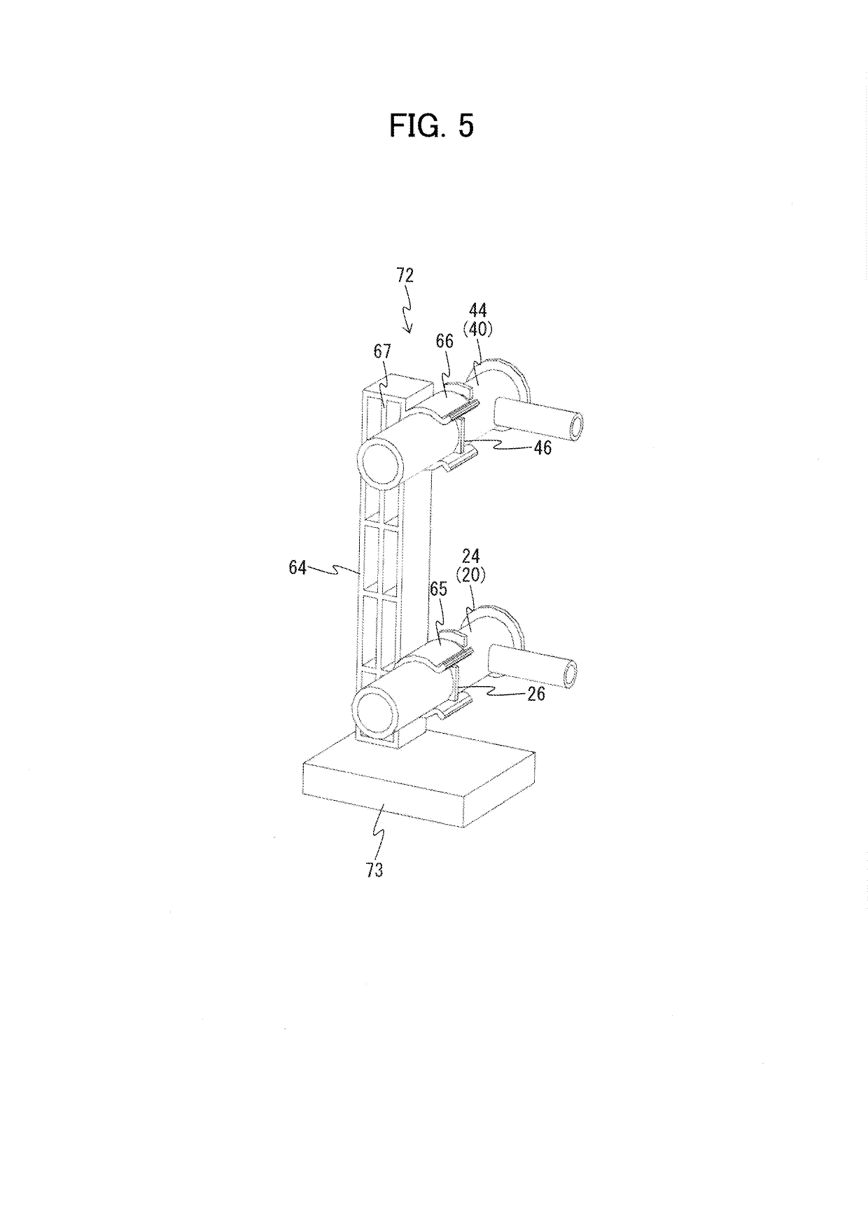

FIG. 5 is a perspective view showing the second support member 72. The second support member 72 includes a base portion 73, the main body 64, a first clip portion 65, a second clip portion 66, and a reinforcing portion 67. Since the configurations of the main body 64, the first clip portion 65, the second clip portion 66, and the reinforcing portion 67 of the second support member 72 are the same as the configurations of the main body 64, the first clip portion 65, the second clip portion 66, and the reinforcing portion 67 of the first support member 62, detailed description thereof will be omitted. Meanwhile, since the second support member 72 is located at both the front and rear ends in the front-rear direction, the length of the base portion 73 of the second support member 72 is shorter than the length of the base portion 63 of the first support member 62. Therefore, the second support member 72 can be installed in a limited space.

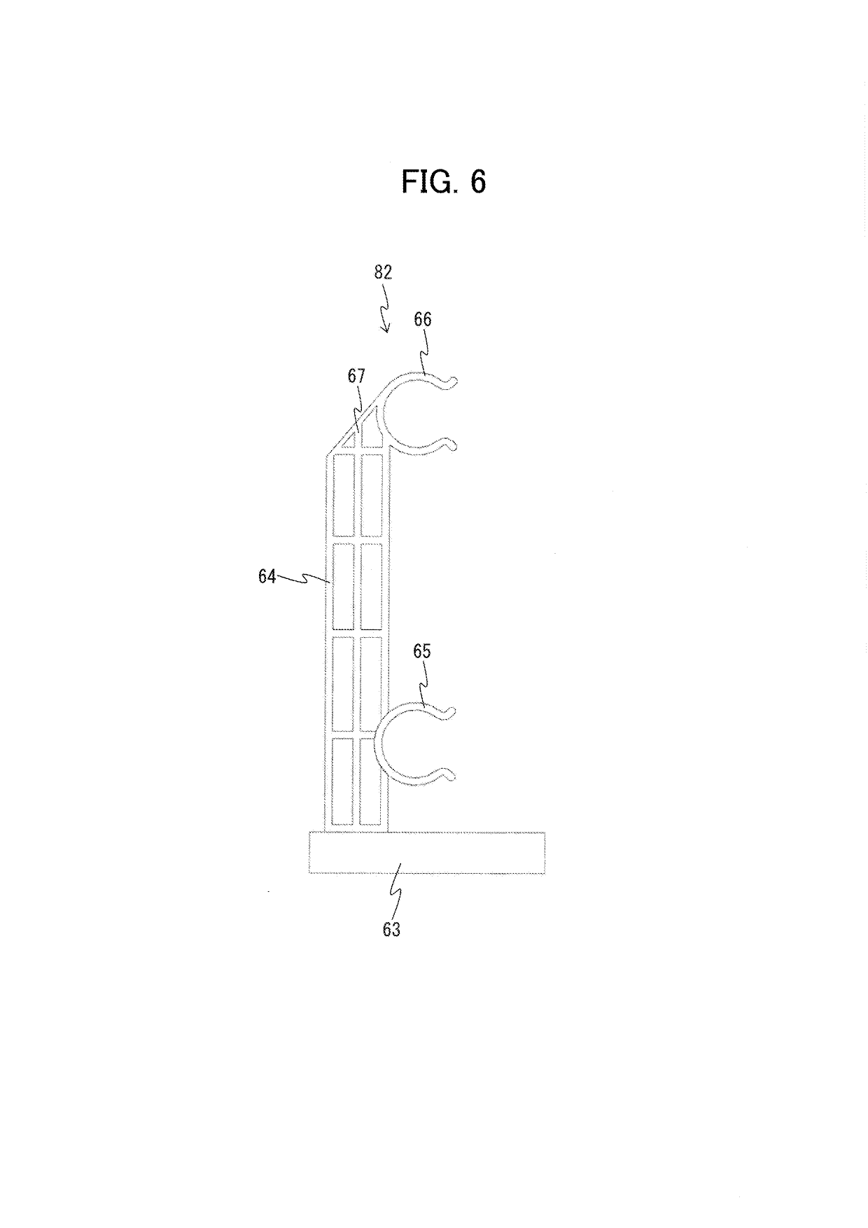

In the above description, the first support member 62 and the second support member 72 have their respective reinforcing portions 67, but the present disclosure is not limited thereto, and for example, the first support member 62 and the second support member 72 may be configured without the reinforcing portions 67. FIG. 6 is a schematic diagram illustrating a first support member 82 according to a modification. The first support member 82 according to the modification does not include the reinforcing portion 67. However, except for the reinforcing portion 67, the configuration of the first support member 82 according to the modification is the same as the configuration of the first support member 62 described above.

### Effects of the present embodiment

The battery pack 1 of the above-described embodiment includes: the supply pipe 20 and the discharge pipe 40 that are provided along the front-rear direction between the battery module 10L and the battery module 10R, which are disposed at predetermined intervals in the left-right direction. The cooling member 14 of the battery module 10L is connected to the first branch pipe 30L of the supply pipe 20 and the second branch pipe 50L of the discharge pipe 40, and the cooling member 14 of the battery module 10R is connected to the first branch pipe 30R of the supply pipe 20 and the second branch pipe 50R of the discharge pipe 40. The supply pipe 20 and the discharge pipe 40 are arranged one above the other. In the case of the above configuration, the supply pipe 20 and the discharge pipe 40 are located centrally relative to the battery module 10L and the battery module 10R. As a result, the flow of refrigerant from the supply pipe 20 to the battery module 10L via the first branch pipe 30L tends to match the flow of refrigerant from the battery module 10R via the first branch pipe 30R. Similarly, the flow of refrigerant from the battery module 10L to the discharge pipe 40 via the second branch pipe 50L tends to match the flow of refrigerant from the battery module 10R to the discharge pipe 40 via the second branch pipe 50R. As a result, the cooling of the battery module 10L and the battery module 10R by the refrigerant becomes uniform.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A battery pack comprising:
two battery modules, each having a battery cell and a cooling member, with a flow path therein, for cooling the battery cell, and spaced apart from each other in a first direction;
a supply pipe provided between the two battery modules along a second direction orthogonal to the first direction and through which refrigerant supplied to the flow path of the cooling member flows;
two first branch pipes that branch from the supply pipe along the first direction and respectively guide the refrigerant into the flow paths of the cooling members of the two battery modules;
a discharge pipe provided between the two battery modules along the second direction, through which discharged refrigerant flows; and
two second branch pipes that branch from the discharge pipe along the first direction and into which the refrigerant is discharged from the flow path of the cooling member of each of the two battery modules, wherein the supply pipe and the discharge pipe are arranged in a third direction orthogonal to the first direction and the second direction.

2. The battery pack according to claim 1, wherein the supply pipe and the discharge pipe are spaced apart by a predetermined distance in the third direction.

3. The battery pack according to claim 1, wherein the supply pipe and the discharge pipe are located at the same position in the first direction.

4. The battery pack according to claim 1, wherein the lengths of the two first branch pipes are equal, and ｔhe lengths of the two second branch pipes are equal.

5. The battery pack according to claim 1, wherein the third direction is a vertical direction, and, along the third direction, the supply pipe is located below and the discharge pipe is located above.

6. The battery pack according to claim 1, further comprising:
a support member that supports the supply pipe and the discharge pipe, the supply pipe and the discharge pipe being spaced apart by a predetermined distance in a third direction orthogonal to the first direction and the second direction, and being located at the same position in the first direction.

7. The battery pack according to claim 6, wherein the support member includes:
a first clip portion that is C-shaped and grips an outer periphery of the supply pipe; and
a second clip portion that is C-shaped and grips an outer periphery of the discharge pipe.

8. The battery pack according to claim 7, wherein a first rib is provided on the outer periphery of the supply pipe at a predetermined position along the circumferential direction,
a second rib is provided on an outer periphery of the discharge pipe at a predetermined position along the circumferential direction,
the first rib is located at a distal end opening of the first clip portion, and
the second rib is located at a distal end opening of the second clip portion.

9. The battery pack according to claim 7, wherein the support member is provided along the third direction which is a vertical direction,
the second clip portion is located at an upper end of the support member, and
the support member includes:
a main body provided with the first clip portion and the second clip portion; and
a reinforcing portion that extends upward from the main body to a position above the second clip portion and is coupled to the second clip portion.

10. The battery pack according to claim 6, wherein the supply pipe includes a first coupling member that couples a plurality of tubes forming a flow passage,
the discharge pipe includes a second coupling member that couples a plurality of tubes forming a flow passage, and
the support member supports the first coupling member and the second coupling member.
